(19) United States
(12) Patent Application Publication
(10) Pub. No.: US 2024/0295411 A1
(43) Pub. Date: Sep. 5, 2024

(54) ENVIRONMENT MAP CONSTRUCTION DEVICE, ENVIRONMENT MAP CONSTRUCTING METHOD, AND ENVIRONMENT MAP CONSTRUCTING PROGRAM

(71) Applicant: SONY GROUP CORPORATION, TOKYO (JP)

(72) Inventors: JUNYA SHIRAISHI, TOKYO (JP); TOSHIYUKI HIROI, TOKYO (JP)

(21) Appl. No.: 17/754,776

(22) PCT Filed: Oct. 1, 2020
(86) PCT No.: PCT/JP2020/037484

§ 371 Date: Apr. 12, 2022

(30) Foreign Application Priority Data
Oct. 21, 2019 (JP) 2019-191930

(51) Int. Cl. G01C 21/00

(52) U.S. Cl. CPC G01C 21/3848

(57) ABSTRACT

An environment map construction device includes a data processor and an environment map constructing section. The data processor processes one or a plurality of pieces of recognition data outputted from one or a plurality of external environment recognizing section that recognizes an external environment, on the basis of an environment map of a previous time. The environment map constructing section constructs an environment map of a current time with use of the one or the plurality of pieces of recognition data processed by the data processor.

### TECHNICAL FIELD

The present disclosure relates to an environment map construction device that constructs an environment map, an environment map constructing method, and an environment map constructing program.

### BACKGROUND ART

In recent years, there have been disclosed technologies relating to a mobile body, such as a robot, that recognizes an external environment, and autonomously moves in accordance with the recognized environment (see PTLs 1 to 3, for example).

### CITATION LIST

### Patent Literature

PTL 1: Japanese Unexamined Patent Application Publication No. 2013-132748
PTL 2: Japanese Unexamined Patent Application Publication No. 2012-248032
PTL 2: Japanese Unexamined Patent Application Publication No. 2011-47836

### SUMMARY OF THE INVENTION

In a mobile body such as a robot, various types of sensors are provided to recognize an external environment, and an environment map corresponding to the external environment is constructed on the basis of sensor data obtained from the various types of sensors. However, in some cases, it is difficult to appropriately construct an environment map due to noise included in sensor data. It is therefore desirable to provide an environment map construction device, an environment map constructing method, and an environment map constructing program that make it possible to appropriately construct an environment map.

An environment map construction device according to an embodiment of the present disclosure includes a data processor and an environment map constructing section. The data processor processes one or a plurality of pieces of recognition data outputted from one or a plurality of external environment recognizing section that recognizes an external environment, on the basis of an environment map of a previous time. The environment map constructing section constructs an environment map of a current time with use of the one or the plurality of pieces of recognition data processed by the data processor.

An environment map constructing method according to an embodiment of the present disclosure includes the following two:
processing one or a plurality of pieces of recognition data outputted from one or a plurality of external environment recognizing sections that recognizes an external environment, on the basis of an environment map of a previous time; and
constructing an environment map of a current time with use of the one or the plurality of pieces of recognition data processed.

An environment map constructing program according to an embodiment of the present disclosure causes a computer to execute the following two:
processing one or a plurality of pieces of recognition data outputted from one or a plurality of external environment recognizing sections that recognizes an external environment, on the basis of an environment map of a previous time; and
constructing an environment map of a current time with use of the one or the plurality of pieces of recognition data processed.

In the environment map construction device, the environment map construction, and the environment map constructing program according to the embodiments of the present disclosure, recognition data used for construction of the environment map of the current time is processed on the basis of the environment map of the previous time. Thus, in the present disclosure, the environment map of the previous time is fed back to the recognition data. Accordingly, it is possible to estimate a structure of a region where the recognition data is obtained, from the environment map of the previous time, for example, and it is possible to specify noise, an outlier, or the like included in the recognition data from the estimated structure.

### BRIEF DESCRIPTION OF DRAWINGS

FIG. 1 is a diagram illustrating a schematic configuration example of an environment map construction device according to an embodiment of the present disclosure.

FIG. 2 is a diagram illustrating a specific example of a schematic configuration of the environment map construction device in FIG. 1.

FIG. 3 is a diagram illustrating a specific example of a schematic configuration of the environment map construction device in FIG. 1.

FIG. 4 is a diagram illustrating a specific example of a schematic configuration of the environment map construction device in FIG. 1.

FIG. 5 is a diagram illustrating a modification example of a schematic configuration of the environment map construction device in FIG. 1.

FIG. 6 is a diagram illustrating a modification example of a schematic configuration of the environment map construction device in FIG. 2.

FIG. 7 is a diagram illustrating a modification example of a schematic configuration of the environment map construction device in FIG. 3.

FIG. 8 is a diagram illustrating a modification example of a schematic configuration of the environment map construction device in FIG. 4.

FIG. 9 is a diagram illustrating a schematic configuration example of a recognition device in FIGS. 2, 3, 6, and 7.

FIG. 10 is a diagram illustrating a schematic configuration example of an environment map construction device according to an example.

FIG. 11 is a diagram illustrating an example of a processing procedure in the environment map construction device in FIG. 10.

FIG. 12 is a diagram illustrating a schematic configuration example of an environment map construction device according to an example.

FIG. 13 is a diagram illustrating an example of a processing procedure in the environment map construction device in FIG. 12.

FIG. 14 is a diagram illustrating a schematic configuration example of an environment map construction device according to an example.

FIG. 15 is a diagram illustrating an example of a processing procedure in the environment map construction device in FIG. 15.

FIG. 16 is a diagram illustrating a schematic configuration example of an environment map construction device according to an example.

FIG. 17 is a diagram illustrating an example of a processing procedure in the environment map construction device in FIG. 16.

FIG. 18 is a diagram illustrating a schematic configuration example of an environment map construction device according to an example.

FIG. 19 is a diagram illustrating an example of a processing procedure in the environment map construction device in FIG. 18.

FIG. 20 is a diagram illustrating a schematic configuration example of an environment map construction device according to an example.

FIG. 21 is a diagram illustrating an example of a processing procedure in the environment map construction device in FIG. 20.

FIG. 22 is a diagram illustrating a schematic configuration example of an environment map construction device according to an example.

FIG. 23 is a diagram illustrating an example of a processing procedure in the environment map construction device in FIG. 22.

FIG. 24 is a diagram illustrating a schematic configuration example of an environment map construction device according to an example.

FIG. 25 is a diagram illustrating an example of a processing procedure in the environment map construction device in FIG. 24.

FIG. 26 is a diagram illustrating a schematic configuration example of an environment map construction device according to an example.

FIG. 27 is a diagram illustrating an example of a processing procedure in the environment map construction device in FIG. 26.

FIG. 28 is a diagram illustrating a schematic configuration example of an environment map construction device according to an example.

FIG. 29 is a diagram illustrating an example of a processing procedure in the environment map construction device in FIG. 28.

### MODES FOR CARRYING OUT THE INVENTION

Hereinafter, description is given in detail of embodiments of the present disclosure with reference to the drawings. It is to be noted that, in the present specification and drawings, repeated description is omitted for components substantially having the same functional configuration by assigning the same reference signs.

### 1. BACKGROUND

For example, in a mobile body such as a robot including a camera, environment map construction processing for observing an external environment and creating a map (environment map) around the mobile body in accordance with observed conditions is performed to cause the mobile body to autonomously move in accordance with the external environment. An autonomous mobile type mobile body includes various types of sensors for recognizing an external environment, and an environment map is constructed on the basis of sensor data obtained by the various types of sensors.

The various types of sensors have strong points and weak points with respect to an environment and a subject for each system. Accordingly, in many examples of a recognition system of the autonomous mobile type mobile body, a plurality of sensors is used to mutually compensate for weak points, thereby improving overall robustness. For example, PTL 1 described above discloses a method of improving sensor integrated output by exchanging information among a plurality of sensors. In addition, for example, PTL 2 described above discloses a method of gradually and adaptively integrating a plurality of sensors on the basis of reliability. In addition, for example, PTL 3 described above discloses a method of feeding back an instruction for improvement from a sensor integration section to a sensor data processor.

However, even in these existing technologies, a case frequently occurs where it is not possible to cope with deterioration in sensor data specific to an environment or a subject and appropriately construct a map, thereby not enabling a mobile body to autonomously act. For this reason, in development of the autonomous mobile type mobile body, coping with deterioration in sensor data specific to an environment or a subject is a major technical issue.

In contrast, in view of an environment that surrounds us and in which an autonomous mobile type mobile body is assumed to act in the future, in many cases, the subject has a geometric structure. For example, in many cases, a wall surface, a passage floor surface, a glass window, or the like is configured by a flat surface vertically and horizontally disposed. In view of human recognition and behavior in such an environment, even if there are a region and a moment that are somewhat difficult to see in vision, humans seem to take an appropriate action by imagination and guessing. Specifically, humans seem to compensate for lack of information from a sense of vision by guessing the structure of the region on the basis of geometric information about surroundings or geometric information most recently viewed and recognized, and recognition of the subject as an object and knowledge associated therewith.

In view of the recognition system of the autonomous mobile type mobile body, an abundance of geometric information about surroundings is stored in an environment map. Accordingly, the following description is given of a recognition system that is able to cope with deterioration in sensor data by feeding back an environment map of a previous time to sensor data obtained for constructing an environment map of a current time in the recognition system of the autonomous mobile type mobile body.

### 2. Embodiment

### Configuration

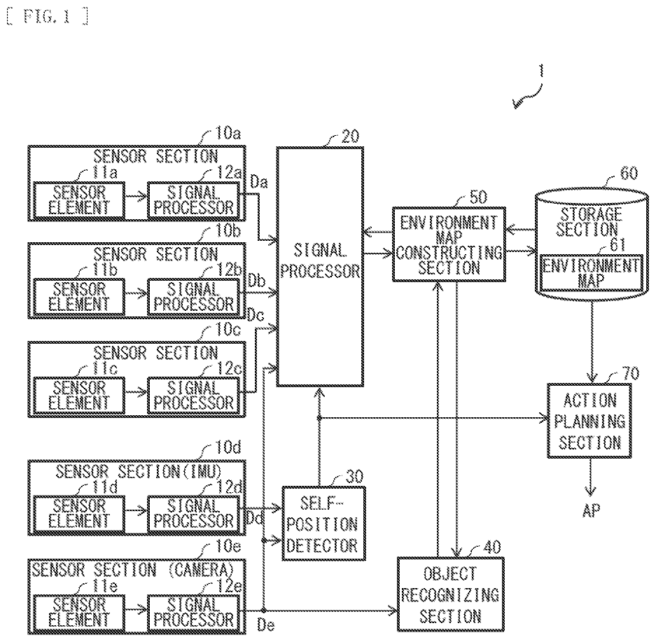

Description is given of a recognition system 1 according to an embodiment of the present disclosure. FIG. 1 illustrates a schematic configuration example of the recognition system 1. For example, as illustrated in FIG. 1, the recognition system 1 includes a plurality of sensor sections 10a to 10e, a signal processor 20, a self-position detector 30, an object recognizing section 40, an environment map constructing section 50, a storage section 60, and an action planning section 70. The sensor sections 10a to 10e include, for example, sensor elements 11a to 11e and signal processors 12a to 12e. The storage section 60 stores an environment map 61. The recognition system 1 corresponds to a specific example of an “environment map construction device” of the present disclosure. Each of the sensor sections 10a to 10c, and 10e corresponds to a specific example of an “external environment recognizing section” of the present disclosure. The signal processor 20 and the signal processors 12a to 12c and 12e correspond to specific examples of a “data processor” of the present disclosure. The storage section 60 corresponds to a specific example of a “storage section” of the present disclosure. The environment map 61 corresponds to a specific example of an “environment map” of the present disclosure.

The sensor elements 11a to 11e recognize an external environment, and output recognition data Da to De corresponding to the recognized external environment. The signal processors 12a to 12e perform predetermined processing on the recognition data Da to De outputted from the respective sensor elements 11a to 11e, and output the processed recognition data Da to De. The signal processor 12a to 12c and 12e output the processed recognition data Da to Dc and De to the signal processor 20. The signal processors 12d and 12e output the processed recognition data Dd and De to the self-position detector 30. The signal processor 12e outputs the processed recognition data De to the object recognizing section 40.

The recognition data Da and the processed recognition data Da each are represented by a coordinate system of the sensor element 11a. The recognition data Db and the processed recognition data Db each are represented by a coordinate system of the sensor element 11b. The recognition data Dc and the processed recognition data De each are represented by a coordinate system of the sensor element 11c. The recognition data Dd and the processed recognition data Dd each are represented by a coordinate system of the sensor element 11d. The recognition data De and the processed recognition data De each are represented by a coordinate system of the sensor element 11e. Relative positions in the recognition system 1 of the sensor elements 11a to 11e are known. Accordingly, for example, it is possible to obtain a transformation relationship between a world coordinate system and the coordinate systems of the sensor elements 11a to 11e from current position data CL of the recognition system 1 represented by the world coordinate system.

The sensor element 11d is, for example, an inertial measurement element (inertial measurement element). The inertial measurement element is configured to include, for example, a three-axis accelerometer and a three-axis gyroscope sensor, and outputs measurement data outputted from these sensors as the recognition data Dd to the signal processor 12d. The signal processor 12d performs predetermined processing on the recognition data Dd inputted from the sensor element 11d, and outputs the processed recognition data Dd to the self-position detector 30.

The sensor element 11e is, for example, a stereo camera. The stereo camera is, for example, a twin-lens CCD (Charge Coupled Device) image sensor or a twin-lens CMOS (Complementary Metal Oxide Semiconductor) image sensor. The stereo camera further generates, for example, parallax data on the basis of two pieces of RAW data obtained by the twin-lens CCD image sensor or the twin-lens CMOS image sensor, and outputs the generated parallax data as the recognition data De to the signal processor 12e. The signal processor 12e performs predetermined processing on the recognition data De inputted from the sensor element 11e, and outputs the processed recognition data De to the signal processor 20, the self-position detector 30, and the object recognizing section 40.

The signal processor 20 processes the recognition data Da to Dc and De inputted from the sensor sections 10a to 10c and 10e on the basis of an environment map Mb of a previous time. The signal processor 20 outputs processed recognition data Da′ to Dc′ and De′ to the environment map constructing section 50. The self-position detector 30 derives the current position data CL of the recognition system 1 on the basis of the recognition data Dd and De inputted from the sensor sections 10d and 10e. The self-position detector 30 outputs the derived current position data CL to the signal processor 20 and the action planning section 70. The object recognizing section 40 derives identification data CO about one or a plurality of objects that is present in the external environment, on the basis of the recognition data De inputted from the sensor section 10e. The identification data CO is, for example, data representing the type (e.g., metal, a mirror, glass, or the like) of the object. The object recognizing section 40 outputs the derived identification data CO to the environment map constructing section 50.

The environment map constructing section 50 constructs an environment map Ma of a current time with use of the recognition data Da′ to Dc′ and De′ processed by the signal processor 20. The environment map constructing section 50 further associates, for example, the identification data CO inputted from the object recognizing section 40 with the environment map Ma of the current time. The environment map constructing section 50 stores the obtained environment map Ma of the current time in the environment map 61 of the storage section 60. The environment map constructing section 50 associates, for example, the identification data CO inputted from the object recognizing section 40 with the obtained environment map Ma of the current time, and stores the identification data CO in the environment map 61 of the storage section 60. The environment map constructing section 50 reads an environment map of a predetermined region including the current position data CL from the environment map 61 stored in the storage section 60, and outputs the read environment map as the environment map Mb of the previous time to the signal processor 20. For example, the identification data CO is associated with the environment map Mb of the previous time.

The storage section 60 includes, for example, a volatile memory such as a DRAM (Dynamic Random Access Memory) or a nonvolatile memory such as an EEPROM (Electrically Erasable Programmable Read-Only Memory) or a flash memory. The storage section 60 stores the environment map 61. The environment map 61 is, for example, a map database including the environment map Ma of the current time inputted from the environment map constructing section 50. The environment map 61, the environment map Ma, and the environment map Mb each are represented by, for example, a world coordinate system. The action planning section 70 creates an action plan on the basis of the environment map 61 read from the storage section 60 and the current position data CL obtained by the self-position detector 30. The action planning section 70 determines what path and in what direction and attitude to move, from the current position data CL obtained by the self-position detector 30, for example, on the basis of the environment map 61 read from the storage section 60, and outputs a result of such determination as an action plan AP.

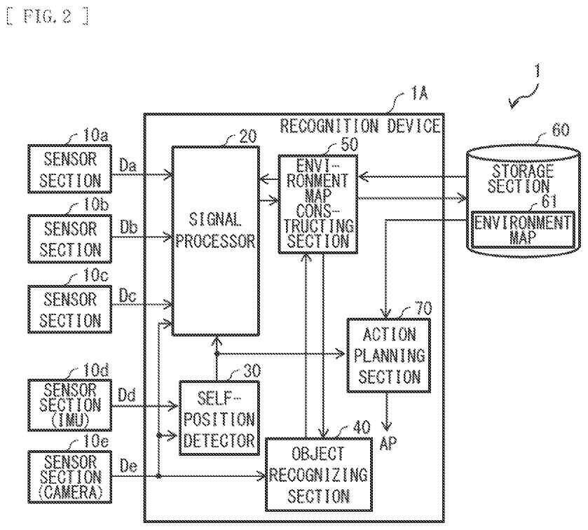

FIG. 2 illustrates a configuration example of the recognition system 1. For example, as illustrated in FIG. 2, the recognition system 1 may include the sensor sections 10a to 10e, a recognition device 1A, and the storage section 60. In this case, the recognition device 1A is, for example, a signal processing substrate provided separately from the sensor sections 10a to 10e and the storage section 60, and is configured to include the signal processor 20, the self-position detector 30, the object recognizing section 40, the environment map constructing section 50, and the action planning section 70. The recognition device 1A regards the recognition data Da to 10e from the sensor sections 10a to 10e as input data, and regards the action plan AP as output data. The recognition device 1A exchanges data with the storage section 60 via the environment map constructing section 50 or the action planning section 70, for example.

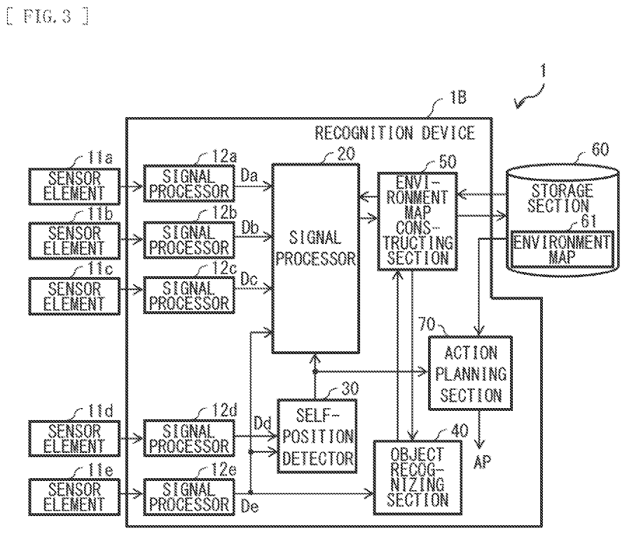

FIG. 3 illustrates a configuration example of the recognition system 1. For example, as illustrated in FIG. 3, the recognition system 1 may include the sensor elements 11a to 11e, a recognition device 1B, and the storage section 60. In this case, the recognition device 1B is, for example, a signal processing substrate provided separately from the sensor elements 11a to 11e and the storage section 60, and is configured to include the signal processors 12a to 12e, the signal processor 20, the self-position detector 30, the object recognizing section 40, the environment map constructing section 50, and the action planning section 70. The recognition device 1B regards the recognition data Da to 10e from the sensor elements 11a to 11e as input data, and regards the action plan AP as output data. The recognition device 1B exchanges data with the storage section 60 via the environment map constructing section 50 or the action planning section 70, for example.

FIG. 4 illustrates a configuration example of the recognition system 1. For example, as illustrated in FIG. 4, the recognition system 1 may include a recognition device 2 and a server device 3. In this case, the recognition device 2 includes, for example, the sensor sections 10a to 10e, the signal processor 20, the self-position detector 30, the object recognizing section 40, the environment map constructing section 50, the action planning section 70, and a communication section 80. The server device 3 includes, for example, the storage section 60.

The recognition device 2 and the server device 3 are coupled to a network 4. The network 4 is, for example, an external network that performs communication with use of a communication protocol (TCP/IP) commonly used on the Internet. The recognition device 2 is coupled to the network 4 via the communication section 80. The communication section 80 is able to communicate with the server device 3 via the network 4.

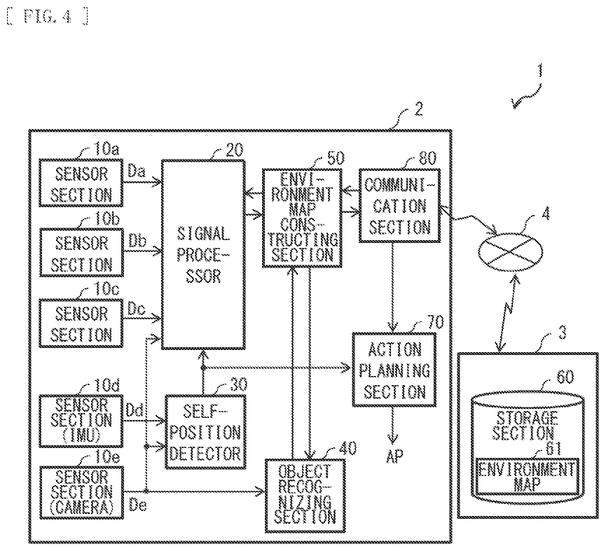

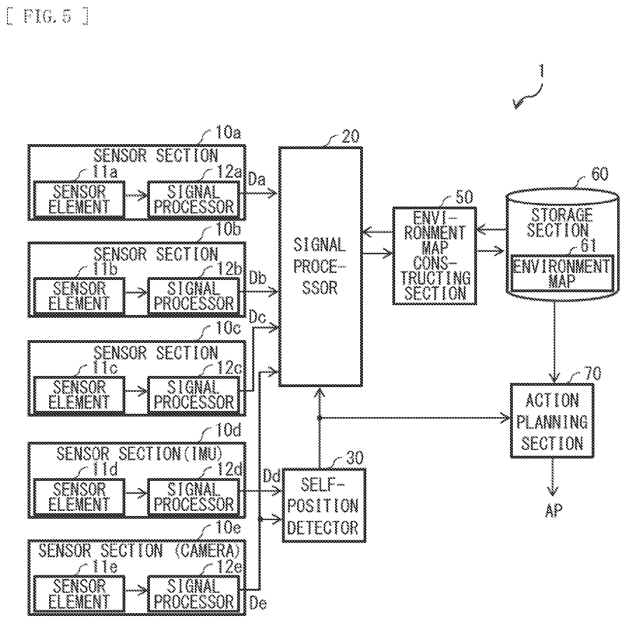

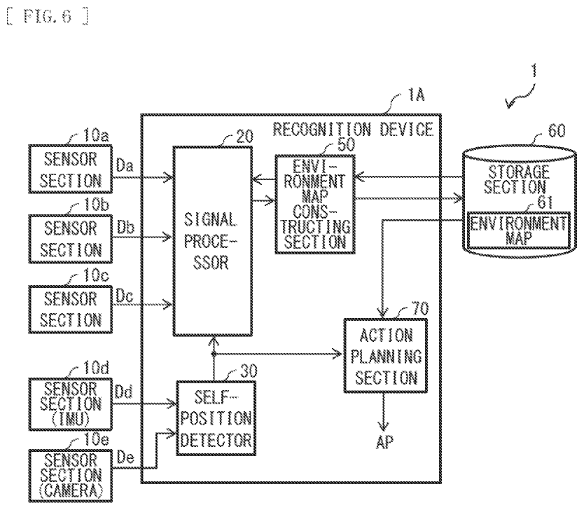

It is to be noted that as illustrated in FIGS. 5, 6, 7, and 8, the object recognizing section 40 may not be included in the recognition system 1.

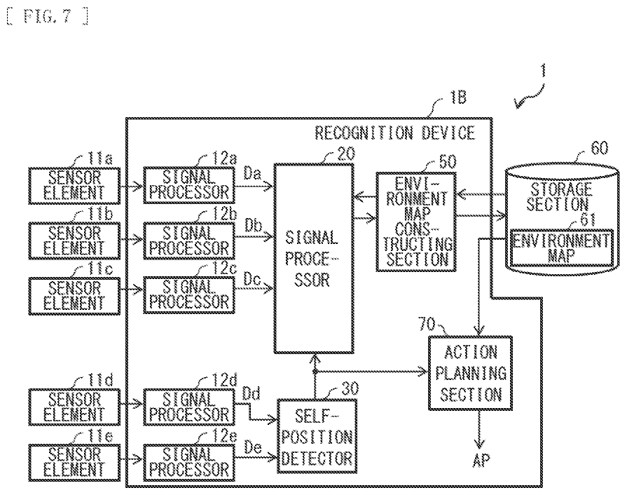

The recognition devices 1A and 1B may include, for example, an operation section 81 and a storage section 82, as illustrated in FIG. 9. In this case, the operation section 81 includes, for example, a CPU (Central Processing Unit) and a GPU (Graphics Processing Unit). The storage section 82 includes, for example, a volatile memory such as a DRAM or a nonvolatile memory such as an EEPROM or a flash memory. The storage section 82 stores an environment map constructing program 82a.

The operation section 81 executes, for example, the environment map constructing program 82a stored in the storage section 82 to execute respective functions of the signal processor 20, the self-position detector 30, the object recognizing section 40, the environment map constructing section 50, and the action planning section 70. In this case, the respective functions of the signal processor 20, the self-position detector 30, the object recognizing section 40, the environment map constructing section 50, and the action planning section 70 are executed by loading the environment map constructing program 82a into the operation section 81.

The operation section 81 may execute, for example, the environment map constructing program 82a stored in the storage section 82 to execute respective functions of the signal processors 12a to 12e, the signal processor 20, the self-position detector 30, the object recognizing section 40, the environment map constructing section 50, and the action planning section 70. In this case, the respective functions of the signal processors 12a to 12e, the signal processor 20, the self-position detector 30, the object recognizing section 40, the environment map constructing section 50, and the action planning section 70 are executed by loading the environment map constructing program 82a into the operation section 81.

It is to be noted that in a case where the object recognizing section 40 is not included, the operation section 81 executes, for example, the respective functions except for the function of the object recognizing section 40.

### EXAMPLES

Examples of the recognition system 1 are described below.

### Example 1

FIG. 10 illustrates an example of the recognition system 1. In FIG. 10, a sensor section 10x is one of the sensor sections 10a to 10c and 10e. In addition, a coordinate transforming section 21 and a filter section 22 are specific examples of components included in the signal processor 20.

The coordinate transforming section 21 obtains a constraint condition 61a from the environment map 61 (an environment map of a previous time) in the storage section 60. In a case where the storage section 60 is provided in the server device 3, the coordinate transforming section 21 obtains the constraint condition 61a from the environment map 61 (the environment map of the previous time) in the storage section 60 via the communication section 80. The constraint condition 61a includes, for example, geometric data. The coordinate transforming section 21 further performs coordinate transformation processing for transforming the constraint condition 61a from a coordinate system of the environment map 61 (the environment map of the previous time) into a coordinate system of the sensor section 10x, and outputs, to the filter section22, the constraint condition 61b having been subjected to the coordinate transformation processing. A coordinate system of an environment map is represented by, for example, a world coordinate system. A coordinate system of the sensor section 10x at a current time is obtained by, for example, the current position data CL derived by the self-position detector 30 and a relative position of the sensor section 10x in a known system.

The filter section 22 processes recognition data Dx inputted from the sensor section 10x on the basis of the constraint condition 61b inputted from the coordinate transforming section 21. The filter section 22 removes noise or an outlier included in the recognition data Dx inputted from the sensor section 10x on the basis of the constraint condition 61b inputted from the coordinate transforming section 21, for example. The filter section 22 may include, for example, a guided filter described in a reference literature (“Fast Guided Filter” Kaming He Jian Sun, arXiv:1505.00996v1 [cs.CV] 5 May 2015). The filter section 22 may include, for example, a Bayesian filter using least squares regression with a regularization term (ridge regression). Thus, the filter section 22 obtains recognition data Dx′ from which the noise or the outlier is removed. The filter section 22 outputs the processed recognition data Dx′ to the environment map constructing section 50. The environment map constructing section 50 uses the recognition data Dx′ processed by the filter section 22 to construct the environment map Ma of the current time. The environment map constructing section 50 stores the obtained environment map Ma of the current time in the environment map 61 of the storage section 60.

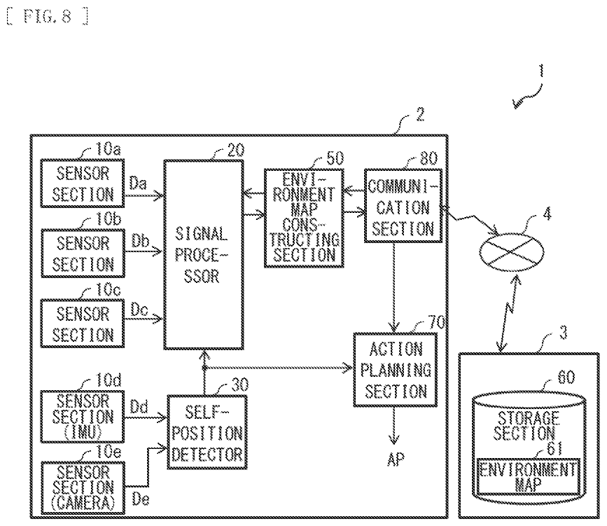

FIG. 11 illustrates an example of a processing procedure in the recognition system 1 in FIG. 10. First, the sensor section 10x obtains the recognition data Dx (step S101). Next, the coordinate transforming section 21 obtains the constraint condition 61a from the environment map 61 (the environment map of the previous time) in the storage section 60 (step S102). The coordinate transforming section 21 next performs coordinate transformation processing for transforming the obtained constraint condition 61a from the coordinate system of the environment map 61 (the environment map of the previous time) into the coordinate system of the sensor section 10x (step S103). Next, the filter section 22 performs filter processing on the recognition data Dx on the basis of the constraint condition 61b having been subjected to coordinate transformation (step S104). The filter section 22 removes noise or an outlier included in the recognition data Dx on the basis of the constraint condition 61b having been subjected to the coordinate transformation, for example. Next, the environment map constructing section 50 constructs the environment map Ma of the current time with use of the processed recognition data Dx′ (step S105). The environment map constructing section 50 stores the obtained environment map Ma of the current time in the environment map 61 of the storage section 60. Thus, processing in the recognition system 1 in FIG. 10 is performed.

### Example 2

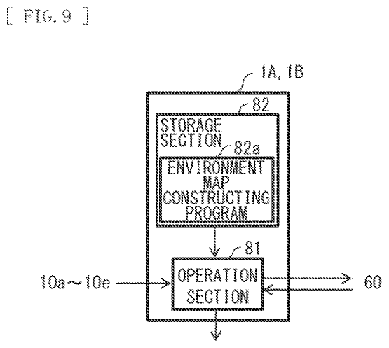

FIG. 12 illustrates an example of the recognition system 1. In FIG. 12, the sensor section 10x is one of the sensor sections 10a to 10c and 10e. In addition, the coordinate transforming section 21, the filter section 22, and a clustering section 23 are specific examples of components included in the signal processor 20. The clustering section 23 corresponds to a specific example of a “shape approximation section” of the present disclosure.

The coordinate transforming section 21 obtains the constraint condition 61a from the environment map 61 (the environment map of the previous time) in the storage section 60. In a case where the storage section 60 is provided in the server device 3, the coordinate transforming section 21 obtains the constraint condition 61a from the environment map 61 (the environment map of the previous time) in the storage section 60 via the communication section 80. The constraint condition 61a includes, for example, geometric data. The coordinate transforming section 21 further performs coordinate transformation processing on the environment map 61 (the environment map of the previous time) for transforming the constraint condition 61a from the coordinate system of the environment map 61 (the environment map of the previous time) into the coordinate system of the sensor section 10x, and outputs, to the filter section 22, the constraint condition 61b having been subjected to the coordinate transformation processing.

In a case where the recognition data Dx includes a plurality of pieces of local data, the clustering section 23 clusters the plurality of pieces of local data to derive a shape approximate expression Fx. For example, in a case where the recognition data Dx is provided as a point group (point cloud), the clustering section 23 aggregates respective points as clusters for each physical size of a region or each point number included in the region to derive the shape approximate expression Fx using, as a parameter, covariance of the respective clusters, a normal vector determined by the covariance of the respective clusters, or the like.

The filter section 22 processes the shape approximate expression Fx inputted from the clustering section 23 on the basis of the constraint condition 61b inputted from the coordinate transforming section 21. The filter section 22 removes noise or an outlier included in the shape approximate expression Fx inputted from the clustering section 23 on the basis of the constraint condition 61b inputted from the coordinate transforming section 21, for example. The filter section 22 may include, for example, a guided filter described in the reference literature (“Fast Guided Filter” Kaming He Jian Sun, arXiv:1505.00996v1 [cs.CV] 5 May 2015). The filter section 22 may include, for example, a Bayesian filter using least squares regression with a regularization term (ridge regression). Thus, the filter section 22 obtains a shape approximate expression Fx′ from which the noise or the outlier is removed. The filter section 22 outputs the processed shape approximate expression Fx′ to the environment map constructing section 50. The environment map constructing section 50 constructs the environment map Ma of the current time with use of the shape approximate expression Fx′ processed by the filter section 22. The environment map constructing section 50 stores the obtained environment map Ma of the current time in the environment map 61 of the storage section 60.

FIG. 13 illustrates an example of a processing procedure in the recognition system 1 in FIG. 12. First, the sensor section 10x obtains the recognition data Dx (step S201). Next, in a case where the recognition data Dx includes a plurality of pieces of local data, the clustering section 23 clusters the plurality of pieces of local data (step S202). Thus, the clustering section 23 derives a shape approximate expression. 1. Next, the coordinate transforming section 21 obtains the constraint condition 61a from the environment map 61 (the environment map of the previous time) in the storage section 60 (step S203). The coordinate transforming section 21 next performs coordinate transformation processing for transforming the obtained constraint condition 61a from the coordinate system of the environment map 61 (the environment map of the previous time) into the coordinate system of the sensor section 10x (step S204). Next, the filter section 22 performs filter processing on the shape approximate expression on the basis of the constraint condition 61b having been subjected to coordinate transformation (step S205). The filter section 22 removes noise or an outlier included in the shape approximate expression on the basis of the constraint condition 61b having been subjected to the coordinate transformation, for example. Next, the environment map constructing section 50 constructs the environment map Ma of the current time with use of the processed shape approximate expression (step S206). The environment map constructing section 50 stores the obtained environment map Ma of the current time in the environment map 61 of the storage section 60. Thus, processing in the recognition system 1 in FIG. 12 is performed.

### Example 3

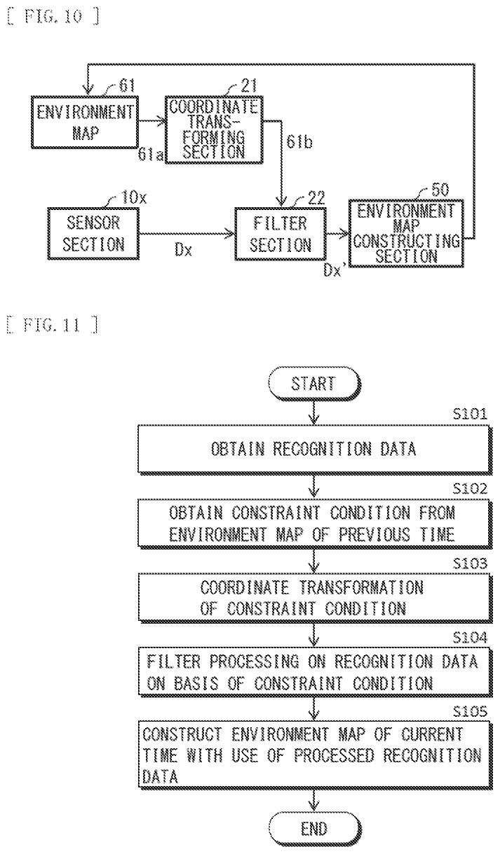

FIG. 14 illustrates an example of the recognition system 1. In FIG. 14, the sensor section 10x is one of the sensor sections 10a to 10c and 10e. In addition, the coordinate transforming section 21, the filter section 22, and a data aggregation section 27 are specific examples of components included in the signal processor 20. The data aggregation section 27 corresponds to a specific example of a “specific point data deriving section” of the present disclosure.

The coordinate transforming section 21 obtains the constraint condition 61a from the environment map 61 (the environment map of the previous time) in the storage section 60. In a case where the storage section 60 is provided in the server device 3, the coordinate transforming section 21 obtains the constraint condition 61a from the environment map 61 (the environment map of the previous time) in the storage section 60 via the communication section 80. The constraint condition 61a includes, for example, geometric data. The coordinate transforming section 21 further performs coordinate transformation processing on the environment map 61 (the environment map of the previous time) for transforming the constraint condition 61a from the coordinate system of the environment map 61 (the environment map of the previous time) into the coordinate system of the sensor section 10x, and outputs, to the filter section 22, the constraint condition 61b having been subjected to the coordinate transformation processing.

In a case where the recognition data Dx includes a plurality of pieces of local data, the data aggregation section 27 performs a data aggregation operation on the plurality of pieces of local data to derive a plurality of pieces of specific point data Ex. For example, in a case where the recognition data Dx is provided as a point group (point cloud), the data aggregation section 27 performs a point thinning operation, a mean value operation in a neighborhood, or the like for derivation of specific point data.

The filter section 22 processes the plurality of pieces of specific point data Ex inputted from the data aggregation section 27 on the basis of the constraint condition 61b inputted from the coordinate transforming section 21. The filter section 22 removes noise or an outlier included in the plurality of pieces of specific point data Ex inputted from the data aggregation section 27 on the basis of the constraint condition 61b inputted from the coordinate transforming section 21, for example. The filter section 22 may include, for example, a guided filter described in the reference literature (“Fast Guided Filter” Kaming He Jian Sun, arXiv: 1505.00996v1 [cs.CV] 5 May 2015). The filter section 22 may include, for example, a Bayesian filter using least squares regression with a regularization term (ridge regression). The filter section 22 outputs, to the environment map constructing section 50, a plurality of pieces of specific point data Ex′ processed. The environment map constructing section 50 constructs the environment map Ma of the current time with use of the plurality of pieces of specific point data Ex′ processed by the filter section 22. The environment map constructing section 50 stores the obtained environment map Ma of the current time in the environment map 61 of the storage section 60.

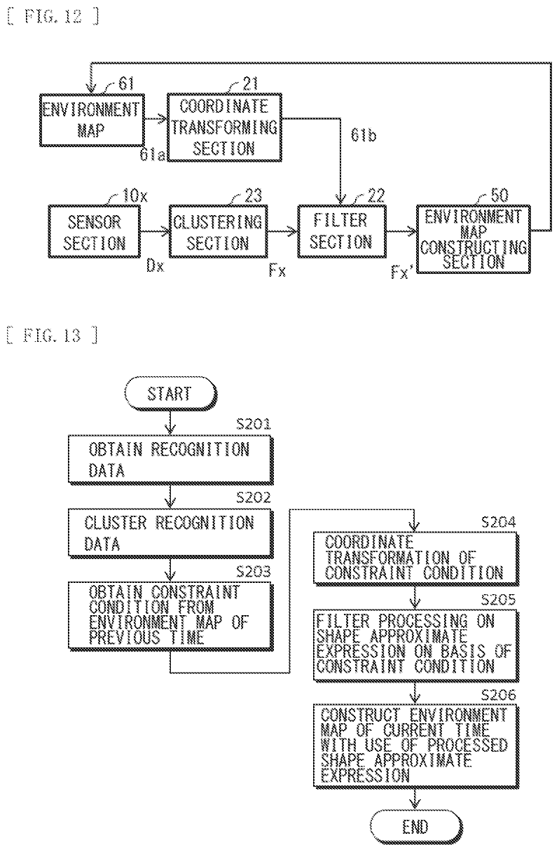

FIG. 15 illustrates an example of a processing procedure in the recognition system 1 in FIG. 14. First, the sensor section 10x obtains the recognition data Dx (step S201). Next, in a case where the recognition data Dx includes a plurality of pieces of local data, the data aggregation section 27 performs a data aggregation operation on the plurality of pieces of local data (step S207). Thus, the data aggregation section 27 derives a plurality of pieces of specific point data Ex. Next, the coordinate transforming section 21 obtains the constraint condition 61a from the environment map 61 (the environment map of the previous time) in the storage section 60 (step S203). The coordinate transforming section 21 next performs coordinate transformation processing for transforming the obtained constraint condition 61a from the coordinate system of the environment map 61 (the environment map of the previous time) into the coordinate system of the sensor section 10x (step S204). Next, the filter section 22 performs filter processing on the plurality of pieces of specific point data Ex on the basis of the constraint condition 61b having been subjected to coordinate transformation (step S208). The filter section 22 removes noise or an outlier included in the plurality of pieces of specific point data Ex on the basis of the constraint condition 61b having been subjected to the coordinate transformation, for example. Next, the environment map constructing section 50 constructs the environment map Ma of the current time with use of a plurality of pieces of specific point data Ex′ processed (step S209). The environment map constructing section 50 stores the obtained environment map Ma of the current time in the environment map 61 of the storage section 60. Thus, processing in the recognition system 1 in FIG. 14 is performed.

### Example 4

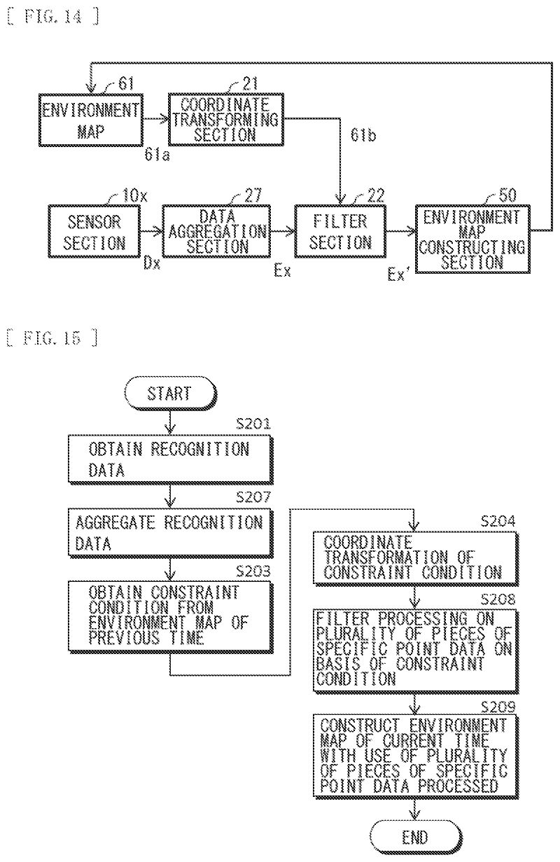

FIG. 16 illustrates an example of the recognition system 1. In FIG. 16, two sensor sections 10×1 and 10×2 are any two of the sensor sections 10a to 10c and 10e. In addition, the coordinate transforming section 21, the filter section 22, and a sensor integration section 24 are specific examples of components included in the signal processor 20.

The coordinate transforming section 21 obtains the constraint condition 61a from the environment map 61 (the environment map of the previous time) in the storage section 60. In a case where the storage section 60 is provided in the server device 3, the coordinate transforming section 21 obtains the constraint condition 61a form the environment map 61 (the environment map of the previous time) in the storage section 60 via the communication section 80. The constraint condition 61a includes, for example, geometric data. The coordinate transforming section 21 further performs coordinate transformation processing on the environment map 61 (the environment map of the previous time) for transforming the constraint condition 61a from the coordinate system of the environment map 61 (the environment map of the previous time) into coordinate systems of the sensor sections 10×1 and 10×2, and outputs, to the filter section 22, the constraint condition 61b having been subjected to the coordinate transformation processing.

The sensor integration section 24 integrates recognition data D×1 and D×2 obtained from the sensor sections 10×1 and 10×2 by a predetermined method to derive integrated recognition data Gx.

The filter section 22 processes the integrated recognition data Gx inputted from the sensor integration section 24 on the basis of the constraint condition 61b inputted from the coordinate transforming section 21. The filter section 22 removes noise or an outlier included in the integrated recognition data Gx inputted from the sensor integration section 24 on the basis of he constraint condition 61b inputted from the coordinate transforming section 21, for example. The filter section 22 may include, for example, a guided filter described in the reference literature (“Fast Guided Filter” Kaming He Jian Sun, arXiv: 1505.00996v1 [cs.CV] 5 May 2015). The filter section 22 may include, for example, a Bayesian filter using least squares regression with a regularization term (ridge regression). Thus, integrated recognition data Gx′ from which the noise or the outlier is removed is obtained. The filter section 22 outputs the processed integrated recognition data Gx′ to the environment map constructing section 50. The environment map constructing section 50 constructs the environment map Ma of the current time with use of the integrated recognition data Gx′ processed by the filter section 22. The environment map constructing section 50 stores the obtained environment map Ma of the current time in the environment map 61 of the storage section 60.

FIG. 17 illustrates an example of a processing procedure in the recognition system 1 in FIG. 16. First, the sensor sections 10×1 and 10×2 obtain the recognition data D×1 and D×2 (step S301). Next, the sensor integration section 24 integrates the recognition data D×1 and D×2 obtained from the sensor sections 10×1 and 10×2 by the predetermined method (step S302). Thus, the sensor integration section 24 derives the integrated recognition data Gx. Next, the coordinate transforming section 21 obtains the constraint condition 61a from the environment map 61 (the environment map of the previous time) in the storage section 60 (step S303). The coordinate transforming section 21 next performs coordinate transformation processing for transforming the obtained constraint condition 61a from the coordinate system of the environment map 61 (the environment map of the previous time) into the coordinate systems of the sensor sections 10×1 and 10×2 (step S304). Next, the filter section 22 performs filter processing on a shape approximate expression on the basis of the constraint condition 61b having been subjected to coordinate transformation (step S305). The filter section 22 removes noise or an outlier included in the integrated recognition data Gx on the basis of the constraint condition 61b having been subjected to the coordinate transformation, for example. Next, the environment map constructing section 50 constructs the environment map Ma of the current time with use of the processed integrated recognition data Gx′ (step S306). The environment map constructing section 50 stores the obtained environment map Ma of the current time in the environment map 61 of the storage section 60. Thus, processing in the recognition system 1 in FIG. 16 is performed.

### Example 5

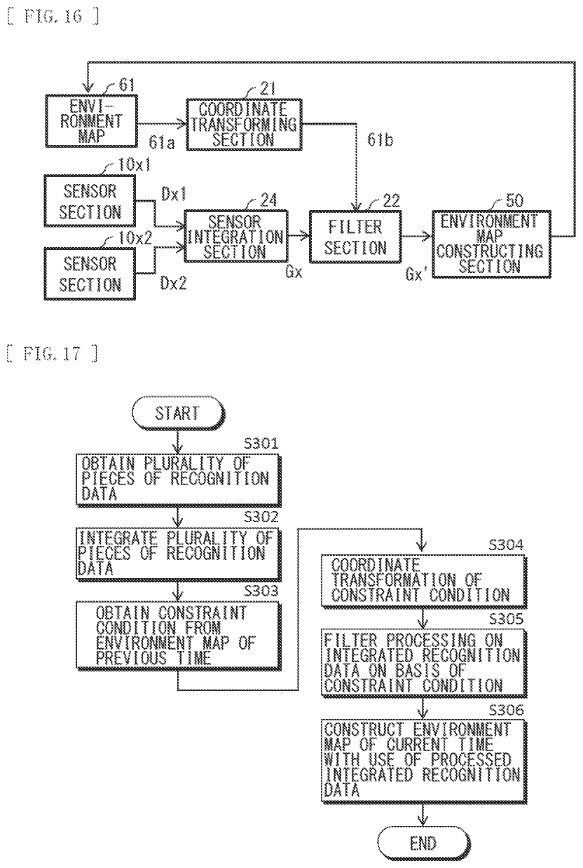

FIG. 18 illustrates an example of the recognition system 1. In FIG. 18, two sensor sections 10×1 and 10×2 are any two of the sensor sections 10a to 10c and 10e. In addition, the coordinate transforming section 21, filter sections 22a and 22b, and the sensor integration section 24 are specific examples of components included in the signal processor 20.

The coordinate transforming section 21 obtains the constraint condition 61a from the environment map 61 (the environment map of the previous time) in the storage section 60. In a case where the storage section 60 is provided in the server device 3, the coordinate transforming section 21 obtains the constraint condition 61a from the environment map 61 (the environment map of the previous time) in the storage section 60 via the communication section 80. The constraint condition 61a includes, for example, geometric data. The coordinate transforming section 21 further performs coordinate transformation processing on the environment map 61 (the environment map of the previous time) for transforming the constraint condition 61a from the coordinate system of the environment map 61 (the environment map of the previous time) into the coordinate systems of the sensor sections 10×1 and 10×2, and outputs, to the filter sections 22a and 22b, the constraint condition 61b having been subjected to the coordinate transformation processing.

The filter section 22a processes the recognition data D×1 inputted from the sensor section 10×1 on the basis of the constraint condition 61b inputted from the coordinate transforming section 21. The filter section 22a removes noise or an outlier included in the recognition data D×1 inputted from the sensor section 10×1 on the basis of the constraint condition 61b inputted from the coordinate transforming section 21, for example. The filter section 22 may include, for example, a guided filter described in the reference literature (“Fast Guided Filter” Kaming He Jian Sun, arXiv: 1505.00996v1 [cs.CV] 5 May 2015). The filter section 22 may include, for example, a Bayesian filter using least squares regression with a regularization term (ridge regression). Thus, the filter section 22a obtains recognition data D×1′ from which the noise or the outlier is removed. The filter section 22a outputs the processed recognition data D×1′ to the sensor

The filter section 22b processes the recognition data D×2 inputted from the sensor section 10×2 on the basis of the constraint condition 61b inputted from the coordinate transforming section 21. The filter section 22b removes noise or an outlier included in the recognition data D×2 inputted from the sensor section 10×2 on the basis of the constraint condition 61b inputted from the coordinate transforming section 21, for example. The filter section 22 may include, for example, a guided filter described in the reference literature (“Fast Guided Filter” Kaming He Jian Sun, arXiv: 1505.00996v1 [cs.CV] 5 May 2015). The filter section 22 may include, for example, a Bayesian filter using least squares regression with a regularization term (ridge regression). Thus, the filter section 22b obtains recognition data D×2′ from which the noise or the outlier is removed. The filter section 22b outputs the processed recognition data D×2′ to the sensor integration section 24.

The sensor integration section 24 integrates the recognition data D×1′ and D×2′ obtained from the filter sections 22a and 22b by a predetermined method to derive integrated recognition data Hx.

The environment map constructing section 50 constructs the environment map Ma of the current time with use of the integrated recognition data Hx inputted from the sensor integration section 24. The environment map constructing section 50 stores the obtained environment map Ma of the current time in the environment map 61 of the storage section 60.

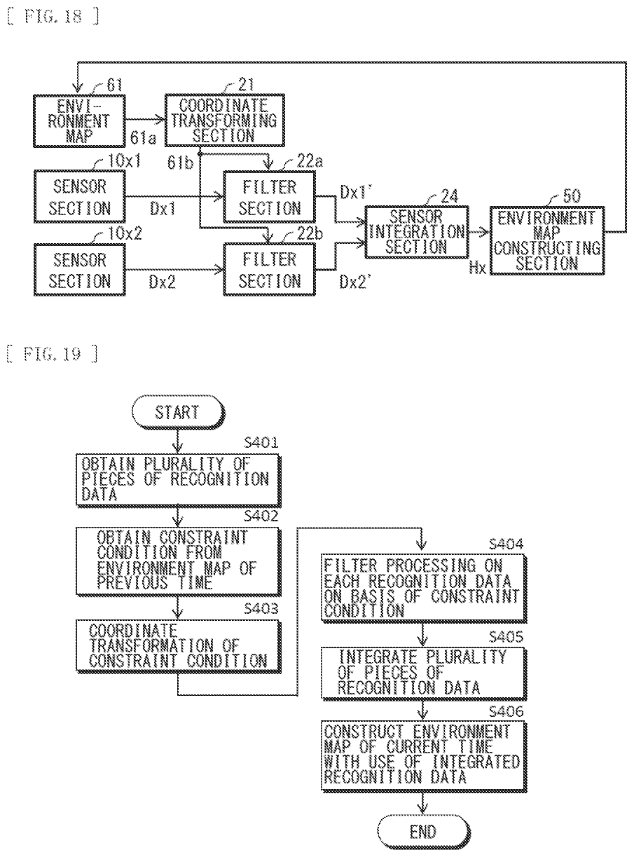

FIG. 19 illustrates an example of a processing procedure in the recognition system 1 in FIG. 18. First, the sensor sections 10×1 and 10×2 obtain the recognition data D×1 and D×2 (step S401). Next, the coordinate transforming section 21 obtains the constraint condition 61a from the environment map 61 (the environment map of the previous time) in the storage section 60 (step S402). The coordinate transforming section 21 next performs coordinate transformation processing for transforming the obtained constraint condition 61a from the coordinate system of the environment map 61 (the environment map of the previous time) into the coordinate systems of the sensor sections 10×1 and 10×2 (step S403). Next, the filter section 22a performs filter processing on the recognition data D×1 on the basis of the constraint condition 61b having been subjected to coordinate transformation, and performs filter processing on the recognition data D×2 on the basis of the constraint condition 61b having been subjected to the coordinate transformation (step S404). The filter section 22a removes noise or an outlier included in the recognition data D×1 on the basis of the constraint condition 61b having been subjected to the coordinate transformation, for example, and the filter section 22b removes noise or an outlier included in the recognition data D×2 on the basis of the constraint condition 61b having been subjected to the coordinate transformation, for example. The sensor integration section 24 integrates the recognition data D×1′ and D×2′ obtained from the filter sections 22a and 22b by the predetermined method (step S405). Thus, the sensor integration section 24 derives the integrated recognition data Hx. Next, the environment map constructing section 50 constructs the environment map Ma of the current time with use of the processed integrated recognition data Hx (step S406). The environment map constructing section 50 stores the obtained environment map Ma of the current time in the environment map 61 of the storage section 60. Thus, processing in the recognition system 1 in FIG. 18 is performed.

### Example 6

FIG. 20 illustrates an example of the recognition system 1. In FIG. 20, two sensor sections 10×1 and 10×2 are any two of the sensor sections 10a to 10c and 10e. In addition, the coordinate transforming section 21, the filter sections 22a and 22b, and the sensor integration section 24 are specific examples of components included in the signal processor 20.

The coordinate transforming section 21 obtains the constraint condition 61a from the environment map 61 (the environment map of the previous time) in the storage section 60. In a case where the storage section 60 is provided in the server device 3, the coordinate transforming section 21 obtains the constraint condition 61a from the environment map 61 (the environment map of the previous time) in the storage section 60 via the communication section 80. The constraint condition 61a includes, for example, geometric data. The coordinate transforming section 21 further performs coordinate transformation processing on the environment map 61 (the previous-tine environment map) for transforming the constraint condition 61a from the coordinate system of the environment map 61 (the environment map of the previous time) into the coordinate systems of the sensor sections 10×1 and 10×2, and outputs, to the filter sections 22a and 22b, the constraint condition 61b having been subjected to the coordinate transformation processing.

The filter section 22a processes the recognition data D×1 inputted from the sensor section 10×1 on the basis of the constraint condition 61b inputted from the coordinate transforming section 21. The filter section 22a removes noise or an outlier included in the recognition data D×1 inputted from the sensor section 10×1 on the basis of the constraint condition 61b inputted from the coordinate transforming section 21, for example. The filter section 22 may include, for example, a guided filter described in the reference literature (“Fast Guided Filter” Kaming He Jian Sun, arXiv: 1505.00996v1 [cs.CV] 5 May 2015). The filter section 22 may include, for example, a Bayesian filter using least squares regression with a regularization term (ridge regression). Thus, the filter section 22a obtains the recognition data D×1′ from which the noise or the outlier is removed. The filter section 22a outputs the processed recognition data D×1′ to the sensor integration section 24.

The filter section 22b processes the recognition data D×2 inputted from the sensor section 10×2 on the basis of the constraint condition 61b inputted from the coordinate transforming section 21. The filter section 22b removes noise or an outlier included in the recognition data D×2 inputted rom the sensor section 10×2 on the basis of the constraint condition 61b inputted from the coordinate transforming section 21, for example. The filter section 22 may include, for example, a guided filter described in the reference literature (“Fast Guided Filter” Kaming He Jian Sun, arXiv: 1505.00996v1 [cs.CV] 5 May 2015). The filter section 22 may include, for example, a Bayesian filter using least squares regression with a regularization term (ridge regression). Thus, the filter section 22b obtains the recognition data D×2′ from which the noise or the outlier is removed. The filter section 22b outputs the processed recognition data D×2′ to the sensor integration section 24.

The object recognizing section 40 derives identification data CO about one or a plurality of objects that is present in an external environment on the basis of recognition data Df inputted from a sensor section 10f. The identification data CO is, for example, data representing the type (e.g., metal, a mirror, glass, or the like) of the object. The object recognizing section 40 outputs the derived identification data CO to the environment map constructing section 50.

The sensor integration section 24 processes the recognition data D×1′ and D×2′ obtained from the filter sections 22a and 22b on the basis of identification data CO of the previous time inputted from the environment map constructing section 50. It is to be noted that at the time of inputting the identification data CO to the sensor integration section 24, the identification data CO inputted to the sensor integration section 24 is identification data CO of the current time. However, at the time of processing the recognition data D×1′ and D×2′, the identification data CO inputted to the sensor integration section 24 corresponds to the identification data CO of the previous time.

The sensor integration section 24 weights the recognition data D×1′ on the basis of the identification data CO of the previous time and characteristics of the sensor section 10×1, for example. The sensor integration section 24 weights the recognition data D×2′ on the basis of the identification data CO of the previous time and characteristics of the sensor section 10×2, for example.

The characteristics of the sensor section 10×1 indicate, for example, data corresponding to a material and the like of an object that is not easily recognized by the sensor section 10×1, and data corresponding to a material and the like of an object that is easily recognized by the sensor section 10×1. The characteristics of the sensor section 10×2 indicate, for example, data corresponding to a material and the like of an object that is not easily recognized by the sensor section 10×2, and data corresponding to a material and the like of an object that is easily recognized by the sensor section 10×2.

The sensor integration section 24 integrates, by a predetermined method, recognition data D×1″ obtained by weighting the recognition data D×1′ and recognition data D×2″ obtained by weighting the recognition data D×2′ to derive integrated recognition data Jx. The sensor integration section 24 outputs the derived integrated recognition data Jx to the environment map constructing section 50.

The environment map constructing section 50 constructs the environment map Ma of the current time with use of the integrated recognition data Jx inputted from the sensor integration section 24. The environment map constructing section 50 stores the obtained environment map Ma of the current time in the environment map 61 of the storage section 60. At this time, the environment map constructing section 50 associates the identification data CO of the current time inputted from the object recognizing section 40 with the environment map Ma of the current time. The environment map constructing section 50 associates the identification data CO of the current time with the environment map Ma of the current time, and stores the identification data CO of the current time in the environment map 61 of the storage section 60. The environment map constructing section 50 further outputs the identification data CO of the current time to the sensor

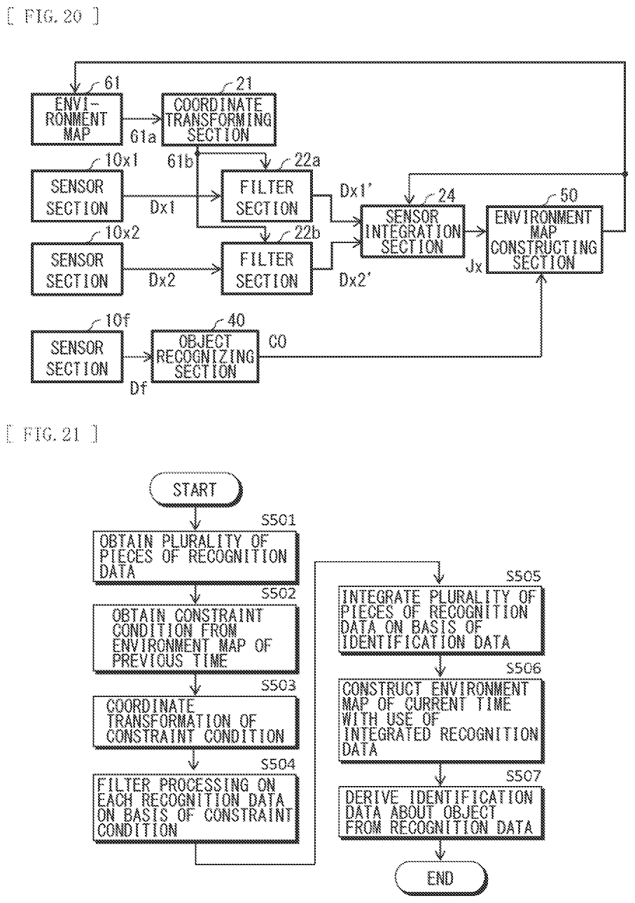

FIG. 21 illustrates an example of a processing procedure in the recognition system 1 in FIG. 20. First, the sensor sections 10×1, 10×2, and 10f obtain recognition data D×1, D×2, and Df (step S501). Next, the coordinate transforming section 21 obtains the constraint condition 61a from the environment map 61 (the environment map of the previous time) in the storage section 60 (step S502). The coordinate transforming section 21 next performs coordinate transformation processing for transforming the obtained constraint condition 61a from the coordinate system of the environment map 61 (the environment map of the previous time) into the coordinate systems of the sensor sections 10×1 and 10×2 (step S503). Next, the filter section 22a performs filter processing on the recognition data D×1 on the basis of the constraint condition 61b having been subjected to coordinate transformation, and the filter section 22b performs filter processing on the recognition data D×2 on the basis of the constraint condition 61b having been subjected to the coordinate transformation (step S504). The filter section 22a removes noise or an outlier included in the recognition data D×1 on the basis of the constraint condition 61b having been subjected to the coordinate transformation, for example, and the filter section 22b removes noise or an outlier included in the recognition data D×2 on the basis of the constraint condition 61b having been subjected to the coordinate transformation, for example.

The sensor integration section 24 processes the recognition data D×1′ and D×2′ obtained from the filter sections 22a and 22b on the basis of the identification data CO of the previous time inputted from the environment map constructing section 50. The sensor integration section 24 weights the recognition data D×1′ on the basis of the identification data CO of the previous time and the characteristics of the sensor section 10×1, for example. The sensor integration section 24 weights the recognition data D×2′ on the basis of the identification data CO of the previous time and the characteristics of the sensor section 10×2, for example. The sensor integration section 24 further integrates, by the predetermined method, the recognition data D×1″ obtained by weighting the recognition data D×1′ and the recognition data D×2″ obtained by weighting the recognition data D×2′ (step S505). Thus, the sensor integration section 24 derives the integrated recognition data Jx.

Next, the environment map constructing section 50 constructs the environment map Ma of the current time with use of the derived integrated recognition data Jx (step S506). The environment map constructing section 50 stores the obtained environment map Ma of the current time in the environment map 61 of the storage section 60.

The object recognizing section 40 derives the identification data CO of the current time on the basis of the recognition data Df inputted from the sensor section 10f (step S507). The object recognizing section 40 outputs the derived identification data CO of the current time to the environment map constructing section 50. The environment map constructing section 50 associates the identification data CO of the current time with the environment map Ma of the current time, and stores the identification data CO of the current time in the environment map 61 of the storage section 60. The environment map constructing section 50 further outputs the identification data CO of the current time to the sensor integration section 24. This makes it possible for the sensor integration section 24 to use the identification data CO inputted from the environment map constructing section 50 as the identification data CO of the previous time in next integration processing. Thus, processing in the recognition system 1 in FIG. 20 is performed.

### Example 7

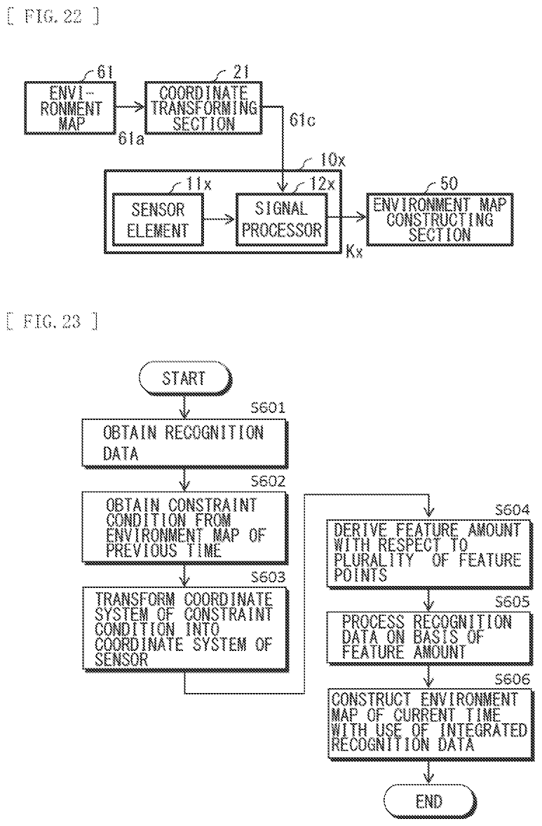

FIG. 22 illustrates an example of the recognition system 1. In FIG. 22, the sensor section 10x is one of the sensor sections 10a to 10c and 10e. In addition, the sensor element 11x is one of the sensor elements 11a to 11c and 11e. In addition, the signal processor 12x is one of the signal processors 12a to 12c and 12e. The coordinate transforming section 21 is a specific example of a component included in the signal processor 20.

The coordinate transforming section 21 obtains the constraint condition 61a from the environment map 61 (the environment map of the previous time) in the storage section 60. In a case where the storage section 60 is provided in the server device 3, the coordinate transforming section 21 obtains the constraint condition 61a from the environment map 61 (the environment map of the previous time) in the storage section 60 via the communication section 80. The constraint condition 61a includes, for example, geometric data. The coordinate transforming section 21 further performs coordinate transformation processing for transforming the constraint condition 61a from the coordinate system of the environment map 61 (the environment map of the previous time) into the coordinate system of the sensor section 10x. The coordinate transforming section 21 further derives a feature amount 61c relating to certainty with respect to a plurality of feature points in the constraint condition 61b having been subjected to the coordinate transformation processing. The coordinate transforming section 21 outputs the derived feature amount 61c to the signal processor 12x. The feature amount 61c is, for example, a probability distribution of certainty with respect to the plurality of feature points.

The coordinate transforming section 21 may perform, on the constraint condition 61a, not only coordinate transformation processing but also processing considering a model relating to sensitivity of the sensor element 11x. For example, it is assumed that in the sensor element 11x, sensitivity in a front direction and sensitivity in a lateral direction are different from each other. In this case, in the recognition data D×, data corresponding to the front direction of the sensor element 11x has a relatively small error, and data corresponding to the lateral direction of the sensor element 11x has a relatively large error. The coordinate transforming section 21 may store such an error distribution in the sensor element 11x as a model relating to sensitivity of the sensor element 11x, and may perform correction considering the model relating to sensitivity of the sensor element 11x on the constraint condition 61a to be provided to the signal processor 12x corresponding to the sensor element 11x.

The signal processor 12x processes the recognition data Dx inputted from the sensor element 11x on the basis of the feature amount 61c inputted from the coordinate transforming section 21. The signal processor 12x weights the recognition data Dx inputted from the sensor section 10x on the basis of the feature amount 61C inputted from the coordinate transforming section 21, for example. Thus, the signal processor 12x obtains weighted recognition data Kx. For example, in a case of a stereo camera, the feature amount is a value indicating certainty of feature points in a camera image, and the signal processor 12x performs a parallax operation of feature points of left and right cameras on the premise of certainty to obtain distance information to a subject as recognition data. The signal processor 12x outputs the processed recognition data Kx to the environment map constructing section 50. The environment map constructing section 50 constructs the environment map Ma of the current time with use of the recognition data Kx processed by the signal processor 12x. The environment map constructing section 50 stores the obtained environment map Ma of the current time in the environment map 61 of the storage section 60.

FIG. 23 illustrates an example of a processing procedure in the recognition system 1 in FIG. 22. First, the sensor element 11x obtains the recognition data Dx (step S601). Next, the coordinate transforming section 21 obtains the constraint condition 61a from the environment map 61 (the environment map of the previous time) in the storage section 60 (step S602). The coordinate transforming section 21 next performs coordinate transformation processing for transforming the obtained constraint condition 61a from the coordinate system of the environment map 61 (the environment map of the previous time) into the coordinate system of the sensor section 10x (step S603). At this time, the coordinate transforming section 21 may perform, on the constraint condition 61a, processing (sensitivity processing) considering the model relating to sensitivity of the sensor element 11x, as necessary.

The coordinate transforming section 21 derives the feature amount 61c relating to certainty with respect to a plurality of feature points in the constraint condition 61b having been subjected to the coordinate transformation processing or the constraint condition 61b having been subjected to the coordinate transformation processing and the sensitivity processing (step S604). Next, the signal processor 12x processes the recognition data Dx inputted from the sensor element 11x on the basis of the feature amount 61c inputted from the coordinate transforming section 21 (step S605). The signal processor 12x weights the recognition data Dx inputted from the sensor section 10x on the basis of the feature amount 61c inputted from the coordinate transforming section 21, for example. Thus, the signal processor 12x obtains the weighted recognition data Kx. The environment map constructing section 50 constructs the environment map Ma of the current time with use of the recognition data Kx processed by the signal processor 12x (step S606). The environment map constructing section 50 stores the obtained environment map Ma of the current time in the environment map 61 of the storage section 60. Thus, processing in the recognition system 1 in FIG. 22 is performed.

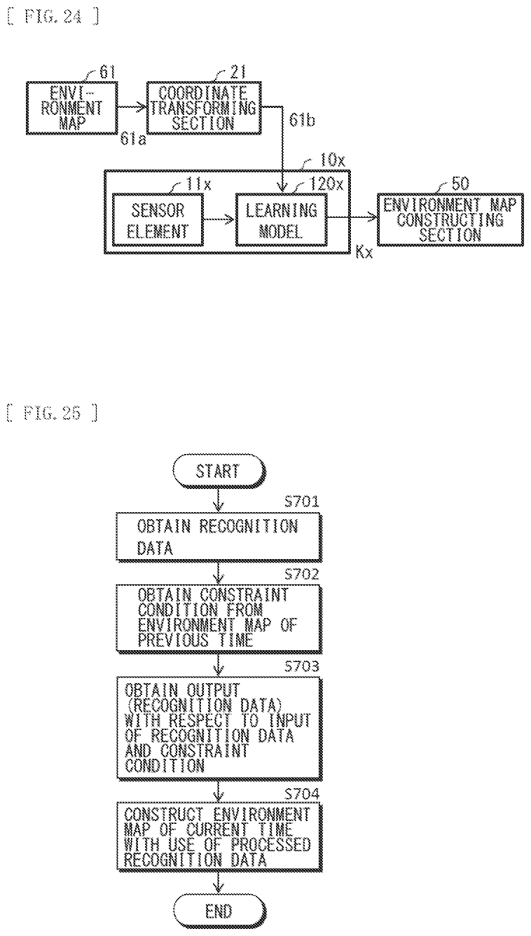

It is to be noted that in Example 7, as illustrated in FIG. 24, a learning model 120x may be provided in place of the signal processor 12x. In this case, the learning model 120x is a learning model having been subjected to machine learning that uses, as explanatory variables, the constraint condition 61b obtained from the environment map Mb of the previous time and the recognition data Dx outputted from the sensor element 11x and uses, as an objective variable, the recognition data Kx having been subjected to processing based on the constraint condition 61b obtained from the environment map Mb of the previous time. The learning model 120x is, for example, a multilayer neural network. The constraint condition 61b inputted upon learning of the learning model 120x is, for example, the constraint condition 61b having been subjected to the coordinate transformation processing or the constraint condition 61b having been subjected to the coordinate transformation processing and the sensitivity processing.

In a case where the learning model 120x is provided in place of the signal processor 12x, the coordinate transforming section 21 inputs, to the learning model 120x, the constraint condition 61b having been subjected to the coordinate transformation processing or the constraint condition 61b having been subjected to the coordinate transformation processing and the sensitivity processing.

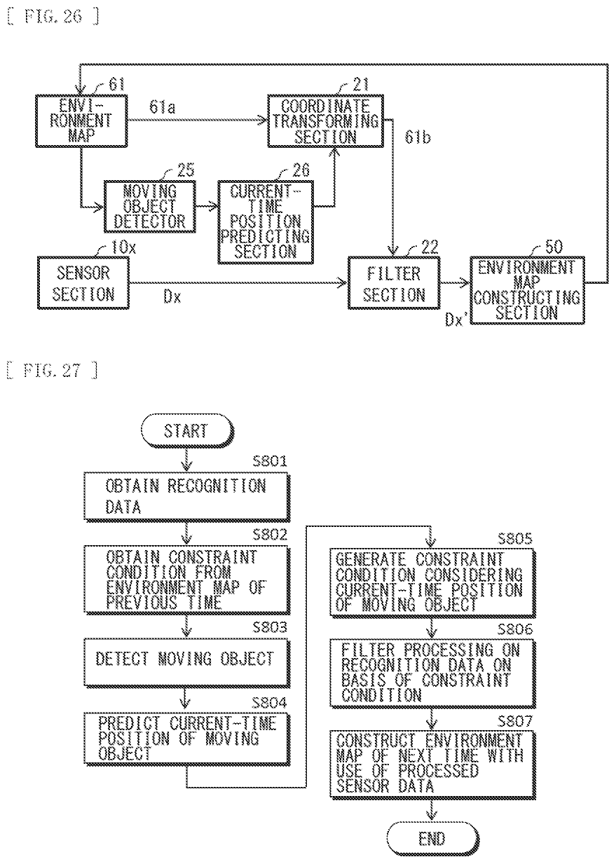

FIG. 25 illustrates an example of a processing procedure in the recognition system 1 in FIG. 24. First, the sensor element 11x obtains the recognition data Dx (step S701). Next, the coordinate transforming section 21 obtains the constraint condition 61a from the environment map 61 (the environment map of the previous time) in the storage section 60 (step S702). The coordinate transforming section 21 performs the coordinate transformation processing for transforming the constraint condition 61a from the coordinate system of the environment map 61 (the environment map of the previous time) into the coordinate system of the sensor section 10x, as necessary. The coordinate transforming section 21 further performs the sensitivity processing on the constraint condition 61a, as necessary.

Next, the learning model 120x processes the recognition data Dx inputted from the sensor element 11x on the basis of the constraint condition 61b inputted from the coordinate transforming section 21, thereby outputting the recognition data Kx. The environment map constructing section 50 obtains output (the recognition data Kx) with respect to input of the recognition data Dx and the constraint condition 61b from the learning model 120x in such a manner (step S703). The environment map constructing section 50 constructs the environment map Ma of the current time with use of the recognition data Kx obtained from the learning model 120x (step S704). The environment map constructing section 50 stores the obtained environment map Ma of the current time in the environment map 61 of the storage section 60. Thus, processing in the recognition system 1 in FIG. 24 is performed.

### Example 8

FIG. 26 illustrates an example of the recognition system 1. In FIG. 26, the sensor section 10x is one of the sensor sections 10a to 10c and 10e. In addition, the coordinate transforming section 21, the filter section 22, a moving object detector 25, and a current-time position predicting section 26 are specific examples of components included in the signal processor 20.

The moving object detector 25 detects one or a plurality of moving objects included in the environment map 61 (the environment map of the previous time) in the storage section 60. The current-time position predicting section 26 predicts a current-time position at a current time of the one or the plurality of moving objects detected by the moving object detector 25.

The coordinate transforming section 21 obtains the constraint condition 61a from the environment map 61 (the environment map of the previous time) in the storage section 60. In a case where the storage section 60 is provided in the server device 3, the coordinate transforming section 21 obtains the constraint condition 61a from the environment map 61 (the environment map of the previous time) in the storage section 60 via the communication section 80. The constraint condition 61a includes, for example, geometric data. The coordinate transforming section 21 further corrects the constraint condition 61a on the basis of the current-time position (the current position data CL) at the current time of the one or the plurality of moving objects obtained by the current-time position predicting section 26. The coordinate transforming section 21 performs coordinate transformation processing for transforming a constraint condition 61a′ obtained by correction from the coordinate system of the environment map 61 (the environment map of the previous time) into the coordinate system of the sensor section 10x, and outputs, to the filter section 22, the constraint condition 61b having been subjected to the coordinate transformation processing.

The filter section 22 processes the recognition data Dx inputted from the sensor section 10x on the basis of the constraint condition 61b inputted from the coordinate transforming section 21. The filter section 22 removes noise or an outlier included in the recognition data Dx inputted from the sensor section 10x on the basis of the constraint condition 61b inputted from the coordinate transforming section 21, for example. The filter section 22 may include, for example, a guided filter described in the reference literature (“Fast Guided Filter” Kaming He Jian Sun, arXiv: 1505.00996v1 [cs.CV] 5 May 2015). The filter section 22 may include, for example, a Bayesian filter using least squares regression with a regularization term (ridge regression). Thus, the filter section 22 obtains the recognition data D×′ from which the noise or the outlier is removed. The filter section 22 outputs the processed recognition data D×′ to the environment map constructing section 50. The environment map constructing section 50 constructs the environment map Ma of the current time with use of the recognition data D×′ processed by the filter section 22. The environment map constructing section 50 stores the obtained environment map Ma of the current time in the environment map 61 of the storage section 60.

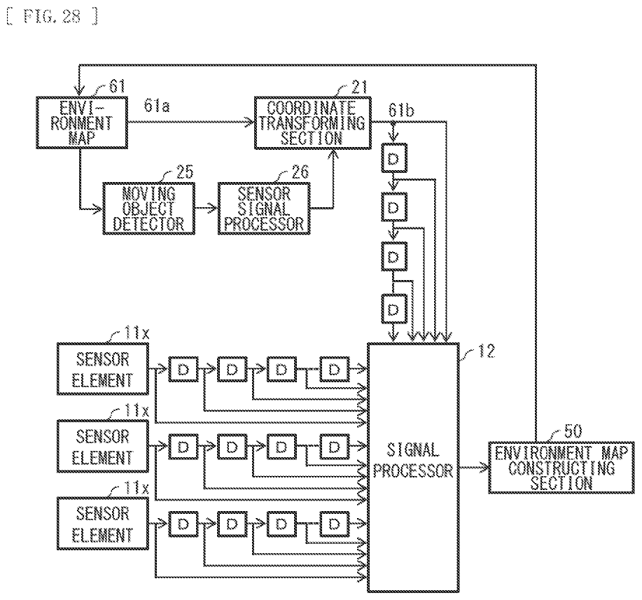

FIG. 27 illustrates an example of a processing procedure in the recognition system 1 in FIG. 26. First, the sensor section 10x obtains the recognition data Dx (step S801). Next, the coordinate transforming section 21 obtains the constraint condition 61a from the environment map 61 (the environment map of the previous time) in the storage section 60 (step S802). Next, the moving object detector 25 detects one or a plurality of moving objects included in the environment map 61 (the environment map of the previous time) in the storage section 60 (step S803). Next, the current-time position predicting section 26 estimates the current-time position at the current time of the one or the plurality of moving objects detected by the moving object detector 25 (step S804).

Thereafter, the coordinate transforming section 21 generates a constraint condition 61a′ considering the current-time position (the current position data CL) at the current time of the one or the plurality of moving objects obtained by the current-time position predicting section 26 (step S805). The coordinate transforming section 21 performs coordinate transformation processing for transforming the constraint condition 61a′ obtained by correction from the coordinate system of the environment map 61 (the environment map of the previous time) into the coordinate system of the sensor section 10x, and outputs, to the filter section 22, the constraint condition 61b having been subjected to the coordinate transformation processing.

Next, the filter section 22 performs filter processing on the recognition data Dx on the basis of the constraint condition 61b having been subjected to coordinate transformation (step S806). The filter section 22 removes noise or an outlier included in the recognition data Dx on the basis of the constraint condition 61b having been subjected to the coordinate transformation, for example. Next, the environment map constructing section 50 constructs the environment map Ma of the current time with use of the processed recognition data D×′ (step S807). The environment map constructing section 50 stores the obtained environment map Ma of the current time in the environment map 61 of the storage section 60. Thus, processing in the recognition system 1 in FIG. 26 is performed.

### Example 9

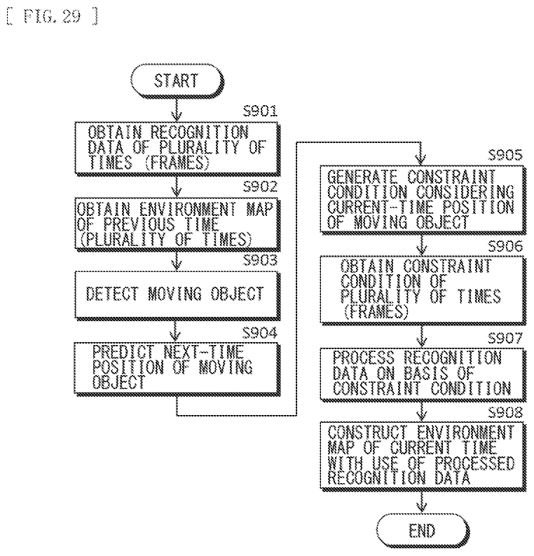

FIG. 28 illustrates an example of the recognition system 1. In FIG. 28, the sensor element 11x is one of the sensor elements 11a to 11c and 11e. In addition, the signal processor 12x is one of the signal processors 12a to 12c and 12e. The coordinate transforming section 21 is a specific example of a component included in the signal processor 20. In FIG. 28, “D” indicates an element that delays the recognition data Dx outputted from the sensor element 11x or the constraint condition 61b outputted from the coordinate transforming section 21 in frame units. Thus, the recognition data Dx of a plurality of past frames outputted from the sensor element 11x is inputted to the signal processor 12.

The moving object detector 25 detects one or a plurality of moving objects included in the environment map 61 (the environment map of the previous time) in the storage section 60. The current-time position predicting section 26 estimates the current-time position at the current time of the one or the plurality of moving objects detected by the moving object detector 25.

The coordinate transforming section 21 obtains the constraint condition 61a from the environment map 61 (the environment map of the previous time) in the storage section 60. In a case where the storage section 60 is provided in the server device 3, the coordinate transforming section 21 obtains the constraint condition 61a from the environment map 61 (the environment map of the previous time) in the storage section 60 via the communication section 80. The constraint condition 61a includes, for example, geometric data. The coordinate transforming section 21 further corrects the constraint condition 61a on the basis of the current-time position (the current position data CL) at the current time of the one or the plurality of moving objects obtained by the current-time position predicting section 26. The coordinate transforming section 21 performs coordinate transformation processing for transforming the constraint condition 61a′ obtained by correction from the coordinate system of the environment map 61 (the environment map of the previous time) into the coordinate system of the sensor section 10x, and outputs, to the signal processor 12, the constraint condition 61b having been subjected to the coordinate transformation processing. The signal processor 12 includes a plurality of signal processors 12x.

The signal processor 12 processes the recognition data Dx inputted from the sensor section 10x on the basis of the constraint condition 61b inputted from the coordinate transforming section 21. The filter section 22 removes noise or an outlier included in the recognition data Dx inputted from the sensor section 10x on the basis of the constraint condition 61b inputted from the coordinate transforming section 21, for example. The filter section 22 may include, for example, a guided filter described in the reference literature (“Fast Guided Filter” Kaming He Jian Sun, arXiv: 1505.00996v1 [cs.CV] 5 May 2015). The filter section 22 may include, for example, a Bayesian filter using least squares regression with a regularization term (ridge regression). Thus, the filter section 22 obtains the recognition data D×′ from which the noise or the outlier is removed. The filter section 22 outputs the processed recognition data D×′ to the environment map constructing section 50. The environment map constructing section 50 constructs the environment map Ma of the current time with use of the recognition data D×′ processed by the filter section 22. The environment map constructing section 50 stores the obtained environment map Ma of the current time in the environment map 61 of the storage section 60.

FIG. 29 illustrates an example of a processing procedure in the recognition system 1 in FIG. 28. First, the signal processor 12 obtains the recognition data Dx of a plurality of times (frames) from the respective sensor elements 11x (step S901). Meanwhile, the coordinate transforming section 21 obtains the constraint condition 61a from the environment map 61 (the environment map of the previous time) in the storage section 60 (step S902). Next, the moving object detector 25 detects one or a plurality of moving objects included in the environment map 61 (the environment map of the previous time) in the storage section 60 (step S903). Next, the current-time position predicting section 26 predicts the current-time position at the current time of the one or the plurality of moving objects detected by the moving object detector 25 (step S904).

Thereafter, the coordinate transforming section 21 generates the constraint condition 611a′ considering the current-time position (the current position data CL) at the current time of the one or the plurality of moving objects obtained by the current-time position predicting section 26 (step S905). The coordinate transforming section 21 performs coordinate transformation processing for transforming the constraint condition 61a′ obtained by correction from the coordinate system of the environment map 61 (the environment map of the previous time) into the coordinate system of the sensor section 10x, and outputs, to the signal processor 12, the constraint condition 61b having been subjected to the coordinate transformation processing. The signal processor 12 obtains the constraint condition 61b of a plurality of times (frames) from the coordinate transforming section 21 (step S906).

Next, the signal processor 12 processes the recognition data Dx of the plurality of times (frames) on the basis of the constraint condition 61b of the plurality of times (frames) (step S907). Thus, the signal processor 12 obtains the recognition data D×′. Next, the environment map constructing section 50 constructs the environment map Ma of the current time with use of the processed recognition data D×′ (step S908). The environment map constructing section 50 stores the obtained environment map Ma of the current time in the environment map 61 of the storage section 60. Thus, processing in the recognition system 1 in FIG. 28 is performed. [Effects]

Next, description is given of effects of the recognition system 1.

In the present embodiment, the recognition data Dx used for construction of the environment map Ma (the environment map 61) of the current time is processed on the basis of the environment map Mb of the previous time. In the present embodiment, the environment map Mb of the previous time is fed back to the recognition data Dx in such a manner. Accordingly, it is possible to estimate a structure of a region where the recognition data Dx is obtained, from the environment map Mb of the previous time, for example, and it is possible to specify noise or an outlier included in the recognition data Dx from the estimated structure. This makes it possible to construct the environment map 61 having higher accuracy or higher disturbance resistance. Thus, it is possible to appropriately construct the environment map 61.

In addition, in the present embodiment, the constraint condition 61a is obtained from the environment map Mb of the previous time, and the recognition data Dx is processed on the basis of the obtained constraint condition 61a. The constraint condition 61a includes, for example, geometric data. Accordingly, it is possible to specify noise, an outlier, or the like included in the recognition data Dx from the constraint condition 61a (geometric data), for example. This makes it possible to construct the environment map 61 having higher accuracy or higher disturbance resistance. Thus, it is possible to appropriately construct the environment map 61.

In addition, in the present embodiment, a plurality of pieces of local data is clustered to derive the shape approximate expression Fx. This makes it possible to reduce an operation amount relating to filter processing, thereby making it possible to achieve the recognition system 1 having a low operation load.

In addition, in the present embodiment, the data aggregation operation is performed on the plurality of pieces of local data to derive a plurality of pieces of specific point data Ex. This makes it possible to reduce the operation amount relating to filter processing, thereby making it possible to achieve the recognition system 1 having a low operation load.

In addition, in the present embodiment, the recognition data Dx is processed on the basis of the constraint condition 61b and the identification data CO about one or a plurality of objects that is present in an external environment. Accordingly, it is possible to effectively specify noise or an outlier caused by the type of the object. This makes it possible to construct the environment map 61 having higher accuracy or higher disturbance resistance. Thus, it is possible to appropriately construct the environment map 61.

In addition, in the present embodiment, the feature amount 61c relating to certainty with respect to a plurality of feature points in the environment map of the previous time is used as a constraint condition for the recognition data D×. This makes it possible to construct the environment map 61 having higher accuracy or higher disturbance resistance. Thus, it is possible to appropriately construct the environment map 61.

In addition, in the present embodiment, coordinate transformation is performed on the constraint condition 61b. This makes it possible to have the constraint condition 61b corresponding to the coordinate system of the sensor element 11x, thereby making it possible to construct the environment map 61 having higher accuracy or higher disturbance resistance. Thus, it is possible to appropriately construct the environment map 61.

In addition, in the present embodiment, not only the coordinate transformation processing but also the processing considering the model relating to sensitivity of the sensor element 11x is performed on the constraint condition 61a. This makes it possible to have the constraint condition 61b corresponding to characteristics of the sensor element 11x, thereby making it possible to construct the environment map 61 having higher accuracy or higher disturbance resistance. Thus, it is possible to appropriately construct the environment map 61.

In addition, in the present embodiment, output of the sensor element 11x is processed by the learning model 120x. This makes it possible to process the output of the sensor element 11x more appropriately, thereby making it possible to construct the environment map 61 having higher accuracy or higher disturbance resistance. Thus, it is possible to appropriately construct the environment map 61.

In addition, in the present embodiment, the current-time position at the current time of one or a plurality of moving objects included in the environment map 61 (the environment map of the previous time) in the storage section 60 is predicted. This makes it possible to construct the environment map 61 having higher accuracy or higher disturbance resistance while making an action plan considering movement of the moving objects, even in a case where the moving objects are present around a mobile body equipped with the recognition system 1. Thus, it is possible to appropriately construct the environment map 61.

In addition, in the present embodiment, the constraint condition 61a is obtained from the environment map 61 (the environment map of the previous time) stored in the storage section 60, and the obtained constraint condition 61a is fed back to the recognition data D×. Accordingly, it is possible to estimate a structure of a region where the recognition data Dx is obtained, from the environment map Mb of the previous time, for example, and it is possible to specify noise, an outlier, or the like included in the recognition data Dx from the estimated structure. This makes it possible to construct the environment map 61 having higher accuracy or higher disturbance resistance. Thus, it is possible to appropriately construct the environment map 61.

In addition, in the present embodiment, the constraint condition 61a is obtained from the environment map 61 (the environment map of the previous time) stored in the storage section 60 via the communication section 80, and the obtained constraint condition 61a is fed back to the recognition data D×. In such a case, it is possible to share the environment map 61 among a plurality of recognition devices 2, thereby making it possible to construct the environment map 61 having higher accuracy or higher disturbance resistance. Thus, it is possible to appropriately construct the environment map 61.

### 3. Modification Examples

In the embodiment described above, the plurality of sensor sections 10a to 10c and 10e is provided. However, in the embodiment described above, only one sensor section may be provided. For example, in the recognition system 1 according to the embodiment described above, only the sensor section 10e may be provided. Even in this case, effects similar to those of the embodiment described above are achieved.

In addition, for example, the present disclosure may have the following configurations.

(1)

An environment map construction device including:

a data processor that processes one or a plurality of pieces of recognition data outputted from one or a plurality of external environment recognizing section that recognizes an external environment, on the basis of an environment map of a previous time; and an environment map constructing section that constructs an environment map of a current time with use of the one or the plurality of pieces of recognition data processed by the data processor.

(2)

The environment map construction device according to (1), in which the data processor obtains a constraint condition from the environment map of the previous time, and processes the one or the plurality of pieces of recognition data on the basis of the obtained constraint condition.

(3)

The environment map construction device according to (2), in which the constraint condition includes geometric data.

(4)

The environment map construction device according to (3), in which the data processor includes a filer section that removes noise or an outlier included in the one or the plurality of pieces of recognition data, on the basis of the geometric data.

(5)

The environment map construction device according to (4), in which the one or the plurality of pieces of recognition data includes a plurality of pieces of local data, the data processor further includes a shape approximation section that clusters the plurality of pieces of local data to derive a shape approximate expression, and the filter section removes noise or an outlier included in the shape approximate expression, on the basis of the geometric data.

(6)

The environment map construction device according to (4), in which the one or the plurality of pieces of recognition data include a plurality of pieces of local data, the data processor further includes a specific point data deriving section that performs a data aggregation operation on the plurality of pieces of local data to derive a plurality of pieces of specific point data, and the filter section removes noise or an outlier included in the plurality of pieces of specific point data, on the basis of the geometric data.

(7)

The environment map construction device according to (2), in which the data processor processes the one or the plurality of pieces of recognition data on the basis of the constraint condition and identification data about one or a plurality of objects that is present in the external environment.

(8)

The environment map construction device according to (2), in which the constraint condition includes a feature amount relating to certainty with respect to a plurality of feature points in the environment map of the previous time.

(9)

The environment map construction device according to (2), in which the data processor performs coordinate transformation processing for transforming the constraint condition from a coordinate system of the environment map of the previous time into a coordinate system of the one or the plurality of external environment recognizing sections, and processes the one or the plurality of pieces of recognition data on the basis of the constraint condition having been subjected to the coordinate transformation processing.

(10)

The environment map construction device according to (9), in which the data processor performs, on the constraint condition, not only the coordinate transformation processing but also processing considering a model relating to sensitivity of the one or the plurality of external environment recognizing sections.

(11)

The environment map construction device according to (1), in which the data processor includes a learning model having been subjected to machine learning that uses, as explanatory variables, a constraint condition obtained from the environment map of the previous time and the one or the plurality of pieces of recognition data outputted from the one or the plurality of external environment recognizing sections, and uses, as an objective variable, one or a plurality of pieces of recognition data having been subjected to processing based on the constraint condition obtained from the environment map of the previous time.

(12)

The environment map construction device according to (2), in which the data processor estimates a current-time position at a current time of one or a plurality of moving objects included in the environment map of the previous time, and generates the constraint condition in consideration of the current-time position obtained by estimation.

(13)

The environment map construction device according to any one of (1) to (10), further including a storage section that stores the environment map of the previous time, in which the data processor obtains the constraint condition from the environment map of the previous time stored in the storage section.

(14)

The environment map construction device according to any one of (1) to (10), further including a communication section that enables communication with an external device that stores the environment map of the previous time via an external network, in which the data processor obtains the constraint condition from the environment map of the previous time stored in the storage section via the communication section.

(15)

An environment map constructing method including:
processing one or a plurality of pieces of recognition data outputted from one or a plurality of external environment recognizing sections that recognizes an external environment, on the basis of an environment map of a previous time; and
constructing an environment map of a current time with use of the one or the plurality of pieces of recognition data processed.
   (16)

An environment map constructing program that causes a computer to execute:
processing one or a plurality of pieces of recognition data outputted from one or a plurality of external environment recognizing sections that recognizes an external environment, on the basis of an environment map of a previous time; and constructing an environment map of a current time with use of the one or the plurality of pieces of recognition data processed.

According to an environment map construction device, environment map construction, and an environment map constructing program according to an embodiment of the present disclosure, an environment map of a previous time is fed back to recognition data, which makes it possible to estimate a structure of a region where recognition data is obtained, from the environment map of the previous time, and makes it possible to specify noise, an outlier, or the like included in the recognition data from the estimated structure. This makes it possible to construct an environment map having higher accuracy or higher disturbance resistance. Thus, it is possible to appropriately construct the environment map.

This application claims the benefit of Japanese Priority Patent Application JP2019-191930 filed with the Japan Patent Office on Oct. 21, 2019, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. An environment map construction device comprising:
a data processor that processes one or a plurality of pieces of recognition data outputted from one or a plurality of external environment recognizing section that recognizes an external environment, on a basis of an environment map of a previous time; and
an environment map constructing section that constructs an environment map of a current time with use of the one or the plurality of pieces of recognition data processed by the data processor.

2. The environment map construction device according to claim 1, wherein the data processor obtains a constraint condition from the environment map of the previous time, and processes the one or the plurality of pieces of recognition data on a basis of the obtained constraint condition.

3. The environment map construction device according to claim 2, wherein the constraint condition includes geometric data.

4. The environment map construction device according to claim 3, wherein the data processor includes a filer section that removes noise or an outlier included in the one or the plurality of pieces of recognition data, on a basis of the geometric data.

5. The environment map construction device according to claim 4, wherein
the one or the plurality of pieces of recognition data includes a plurality of pieces of local data,
the data processor further includes a shape approximation section that clusters the plurality of pieces of local data to derive a shape approximate expression, and
the filter section removes noise or an outlier included in the shape approximate expression, on a basis of the geometric data.

6. The environment map construction device according to claim 4, wherein
the one or the plurality of pieces of recognition data include a plurality of pieces of local data,
the data processor further includes a specific point data deriving section that performs a data aggregation operation on the plurality of pieces of local data to derive a plurality of pieces of specific point data, and
the filter section removes noise or an outlier included in the plurality of pieces of specific point data, on a basis of the geometric data.

7. The environment map construction device according to claim 2, wherein the data processor processes the one or the plurality of pieces of recognition data on a basis of the constraint condition and identification data about one or a plurality of objects that is present in the external environment.

8. The environment map construction device according to claim 2, wherein the constraint condition includes a feature amount relating to certainty with respect to a plurality of feature points in the environment map of the previous time.

9. The environment map construction device according to claim 2, wherein the data processor performs coordinate transformation processing for transforming the constraint condition from a coordinate system of the environment map of the previous time into a coordinate system of the one or the plurality of external environment recognizing sections, and processes the one or the plurality of pieces of recognition data on a basis of the constraint condition having been subjected to the coordinate transformation processing.

10. The environment map construction device according to claim 9, wherein the data processor performs, on the constraint condition, not only the coordinate transformation processing but also processing considering a model relating to sensitivity of the one or the plurality of external environment recognizing sections.

11. The environment map construction device according to claim 1, wherein the data processor includes a learning model having been subjected to machine learning that uses, as explanatory variables, a constraint condition obtained from the environment map of the previous time and the one or the plurality of pieces of recognition data outputted from the one or the plurality of external environment recognizing sections, and uses, as an objective variable, one or a plurality of pieces of recognition data having been subjected to processing based on the constraint condition obtained from the environment map of the previous time.

12. The environment map construction device according to claim 2, wherein the data processor estimates a current-time position at a current time of one or a plurality of moving objects included in the environment map of the previous time, and generates the constraint condition in consideration of the current-time position obtained by estimation.

13. The environment map construction device according to claim 2, further comprising a storage section that stores the environment map of the previous time, wherein
the data processor obtains the constraint condition from the environment map of the previous time stored in the storage section.

14. The environment map construction device according to claim 2, further comprising a communication section that enables communication with an external device that stores the environment map of the previous time via an external network, wherein
the data processor obtains the constraint condition from the environment map of the previous time stored in the storage section via the communication section.

15. An environment map constructing method comprising:
processing one or a plurality of pieces of recognition data outputted from one or a plurality of external environment recognizing sections that recognizes an external environment, on a basis of an environment map of a previous time; and
constructing an environment map of a current time with use of the one or the plurality of pieces of recognition data processed.

16. An environment map constructing program that causes a computer to execute:
processing one or a plurality of pieces of recognition data outputted from one or a plurality of external environment recognizing sections that recognizes an external environment, on a basis of an environment map of a previous time; and
constructing an environment map of a current time with use of the one or the plurality of pieces of recognition data processed.
